(19) United States
(12) Patent Application Publication
(10) Pub. No.: US 2011/0314509 A1
(43) Pub. Date: Dec. 22, 2011

(54) CABLE MODEM AND DOWNSTREAM CHANNEL LOCKING METHOD

(75) Inventor: CHI-FU KOH, Tu-Cheng (TW)

(73) Assignee: HON HAI PRECISION INDUSTRY CO., LTD., Tu-Cheng (TW)

(21) Appl. No.: 12/869,767

(22) Filed: Aug. 27, 2010

(30) Foreign Application Priority Data
Jun. 21, 2010 (CN) 201010204452.3

(51) Int. Cl. H04N 7/173

(52) U.S. Cl. 725/111

(57) ABSTRACT

A cable modem locks one of downstream channels and receives a plurality of frequency plan descriptors from a cable modem terminal system (CMTS) over the locked downstream channel. Each frequency plan descriptor includes a fragment quantity field, a fragment sequence number field, and a frequency information field. The cable modem determines if the plurality of frequency plan descriptors transmitted by the CMTS are all received according to the fragment quantity field and the fragment sequence number field of one currently received frequency plan descriptor. The cable modem obtains frequency plan of the cable modem configured by the CMTS according to the frequency information fields if the plurality of frequency plan descriptors are all received, and then locks other downstream channels according to the obtained frequency plan.

### BACKGROUND

1. Technical Field

Embodiments of the present disclosure relate to modems, and more particularly to a cable modem and a downstream channel locking method.

2. Description of Related Art

Generally, frequency plan of a cable modem is from 93 MHz to 999 MHz, and a 6 MHz channel is retrieved from the frequency plan to downstream data. The first step of cable modem provisioning is to scan a frequency range of the frequency plan to lock onto the downstream channel.

However, because the frequency of the downstream channel is initially unknown, the cable modem should serially scan frequencies through the frequency range of the frequency plan, such as scanning frequencies from 93 MHz to 999 MHz every 6 MHz, namely 93 MHz, 99 MHz, 105 MHz, . . . , 993 MHz, and 999 MHz. As a result, the cable modem requires much time to lock onto the downstream channel. Therefore, a system to resolve this weakness is desired.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of an application environment and functional modules of one embodiment of a cable modem of the present disclosure;

FIG. 2 is a schematic diagram of a frequency plan descriptor transmitted by a cable modem terminal system of FIG. 1;

FIG. 3 is a flowchart of one embodiment of a downstream channel locking method of the present disclosure; and

FIG. 4 is a flowchart of another embodiment of a downstream channel locking method of the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

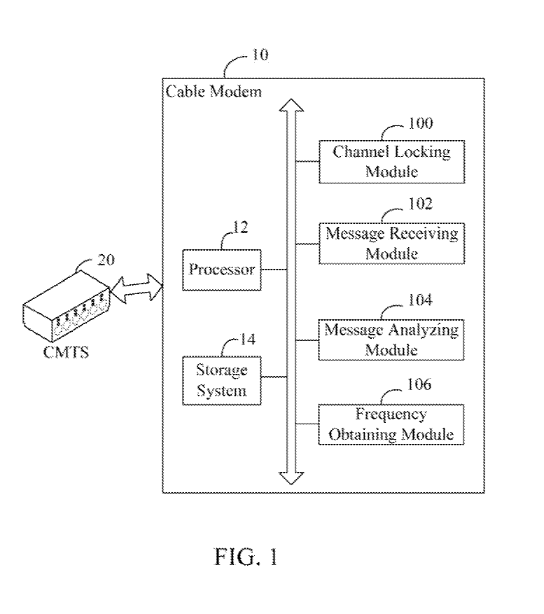

FIG. 1 is a schematic diagram of an application environment and functional modules of one embodiment of a cable modem 10 of the present disclosure. The cable modem 10 is connected to a cable modem termination system (CMTS) 20.

In one embodiment, the cable modem 10 includes a processor 12, a storage system 14, a channel locking module 100, a message receiving module 102, a message analyzing module 104, and a frequency obtaining module 106. The channel locking module 100, the message receiving module 102, the message analyzing module 104, and the frequency obtaining module 106 may include one or more programs comprising computerized code that are stored in the storage system 14 and executed by the processor 12.

The channel locking module 100 scans and locks one of downstream channels of the cable modem. When the cable modem 100 is provisioning at a first time, the cable modem 10 has not communicated with the CMTS 20. Therefore, the cable modem 10 does not know anything about the CMTS 20, and is required to scan frequencies of the cable modem 10 in sequence.

For example, if a standard employed by the cable modem 10 specifies the cable modem 10 to work between 93 MHz and 999 MHz with 6 MHz jumps per time, the cable modem 10 scans 93 MHz to lock a downstream channel. If the cable modem 10 cannot lock a downstream channel, the cable modem 10 scans 99 MHz to lock a downstream channel. If the cable modem 10 locks a downstream channel in 99 MHz, the cable modem 10 stops scanning and communicates with the CMTS 20 through the locked downstream channel.

The CMTS 20 configures frequency plan of the cable modem 10. The frequency plan includes a plurality of frequencies. Generally, a total quantity of the plurality of frequencies configured by the CMTS 20 is much less than that of frequencies defined by a communication standard employed by the cable modem 10. For example, the communication standard employed by the cable modem 10 defines that the cable modem works under 93 MHz to 999 MHz, and then the total quantity of the frequencies the cable modem should scan is 152. However, the CMTS 20 may configure the cable modem 10 to scan frequencies from 693 MHz to 813 MHz, the total quantity of which is 21.

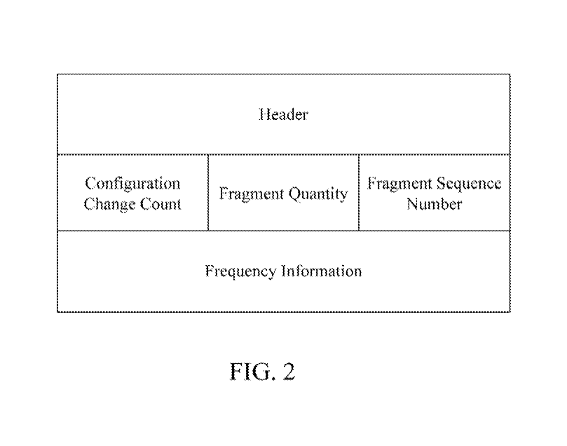

In one embodiment, the CMTS 20 divides the frequency plan into a plurality of frequency plan segments and employs a plurality of frequency plan descriptors to transmit the frequency plan to the cable modem 10. FIG. 2 is a schematic diagram of one of the plurality of frequency plan descriptors transmitted by the CMTS 20. In one embodiment, each frequency plan descriptor is a packet which includes four fields, namely a header field, a fragment quantity field, a fragment sequence number field, and a frequency information field. In other embodiments, to notify the cable modem 10 that the CMTS 20 reconfigures the frequency plan, each frequency plan descriptor further includes a configuration change count field.

In detail, the header is a normal packet header. The fragment quantity field indicates a total quantity of the plurality of frequency plan descriptors employed by the CMTS 20 to transmit the frequency plan to the cable modem 10. The fragment sequence number field indicates a sequence number of one current frequency plan descriptor in the plurality of frequency plan descriptors. For example, if the CMTS 20 employs 6 frequency plan descriptors to transmit the frequency plan to the cable modem 10, then the fragment quantity fields of the 6 frequency plan descriptors may be set as 6, and the fragment sequence number fields of the 6 frequency plan descriptors may be respectively set as 1, 2, 3, 4, 5, and 6.

The frequency information field records one of the frequency plan segments. In detail, the CMTS 20 encodes the frequency plan segments to type-length-value-encoded (TLV-encoded) frequency data, and then stores the TLV-encoded frequency data corresponding to the one of the frequency plan segments in the frequency information field of the one of plurality of frequency plan descriptors. The TLV encoding method is a well-known method of encoding, thus the detail description of the TLV encoding method is omitted.

The configuration change count field indicates whether the CMTS 20 reconfigures the frequency plan for the cable modem or not. For example, the CMTS 20 may set the configuration change count field as 0 to indicate the CMTS 20 does not reconfigure the frequency plan at the beginning. Then, if the CMTS 20 reconfigures the frequency plan, the CMTS 20 changes the configuration change count field, such as setting it as 1. That is, if the configuration change count fields of two frequency plan descriptors are different, then the cable modem 10 may know that the CMTS 20 reconfigures the frequency plan of the cable modem 10.

Referring back to FIG. 1, the CMTS 20 transmits the frequency plan descriptors to the cable modem 10 over the locked downstream channel. The message receiving module 102 receives the plurality of frequency plan descriptors from the CMTS 20 over the locked downstream channel. For example, the channel locking module 100 locks a downstream channel in 93 MHz, the CMTS 20 transmits 3 frequency plan descriptors to the cable modem 10 over the locked downstream channel in 93 MHz, and then the message receiving module 102 receives the 3 frequency plan descriptors over the locked downstream channel in 93 MHz.

To prevent the message receiving module 102 receiving no one frequency plan descriptor, the channel locking module 100 continuously scans and locking another downstream channel of the cable modem when the message receiving module 102 receives none of the plurality of frequency plan descriptors during a preset time period. The preset time period is very short, such as 0.5 seconds or 1 seconds, and is required to be a little bit longer than a normal time period using for normally receiving a normal packet over the downstream channel.

To know whether the CMTS 20 reconfigures the frequency plan of the cable modem, the message analyzing module 104 determines whether the CMTS reconfigures the frequency plan for the cable modem 10 or not according to the configuration change count field of the currently received frequency plan descriptor. To know the lately configured frequency plan from the CMTS 20, the message receiving module 102 discards the frequency plan descriptors which are received before the currently received frequency plan descriptor when the CMTS 20 reconfigures the frequency plan for the cable modem 10.

The message analyzing module 104 determines if the plurality of frequency plan descriptors transmitted by the CMTS 20 are all received when the message receiving module receives one frequency plan descriptor. In one embodiment, the message analyzing module 104 determines if the plurality of frequency plan descriptors transmitted by the CMTS 20 are all received according to the fragment quantity field and the fragment sequence number field of the currently received frequency plan descriptor.

In detail, the message analyzing module 104 determines that the plurality of frequency plan descriptors transmitted by the CMTS 20 are all received when the fragment quantity field is equal to the fragment sequence number field of the currently received frequency plan descriptor. The message analyzing module 104 determines that the plurality of frequency plan descriptors transmitted by the CMTS are not all received when the fragment quantity field is not equal to the fragment sequence number field of the currently received frequency plan descriptor.

For example, if the CMTS 20 transmits 3 frequency plan descriptors to the cable modem 10, then the fragment quantity field may be 3. The fragment sequence number field of the first, second, third frequency plan descriptor may be respectively 1, 2, or 3. Then, if the message receiving module 102 receives the first frequency plan descriptor, then the message analyzing module 104 determines the 3 frequency plan descriptors are not all received because the fragment sequence number field of the first frequency plan descriptor is 1 which is not equal to 3. However, if the message receiving module 102 receives the second frequency plan descriptor and then the third frequency plan descriptor, then the message analyzing module 104 determines the 3 frequency plan descriptors are all received because the fragment sequence number field of the third frequency plan descriptor is 3 which is equal to 3.

The message receiving module 102 continuously receives others of the plurality of frequency plan descriptors from the CMTS 20 over the locked downstream channel when the plurality of frequency plan descriptors transmitted by the CMTS 20 are not all received.

The frequency obtaining module 106 obtains the frequency plan according to the frequency information fields of the plurality of frequency plan descriptors when the plurality of frequency plan descriptors transmitted by the CMTS are all received. The channel locking module 100 scans and locks other downstream channels of the cable modem 10 according to the obtained frequency plan.

In one embodiment, the frequency obtaining module 106 obtains the TLV-encoded frequency data from the frequency information fields of the plurality of frequency plan descriptors and decodes the TLV-encoded frequency data to the frequency plan segments. Then, the frequency obtaining module 106 combines all the frequency plan segments to the frequency plan.

As such, the channel locking module 100 only requires scanning according to the frequency plan configured by the CMTS 20. Therefore, the total quantity of scanned frequency is decreased, and the time cost on the scanning is decreased subsequently.

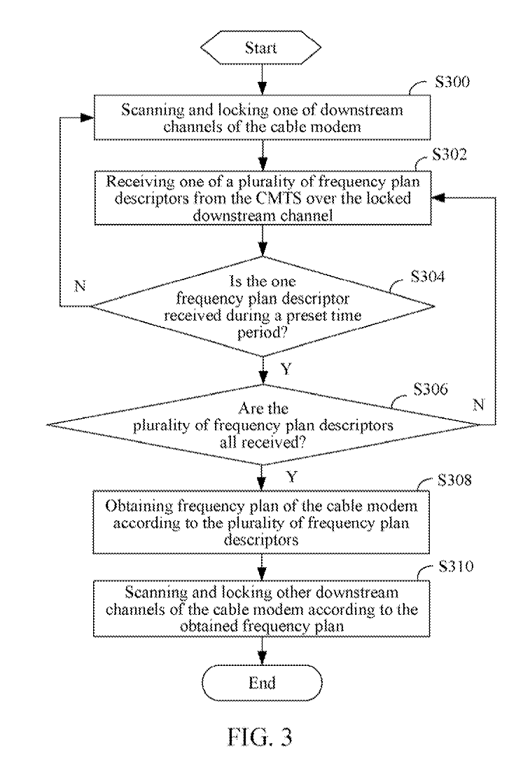

FIG. 3 is a flowchart of one embodiment of a downstream channel locking method of the present disclosure. The method may be embodied in the cable modem 10, and is executed by the functional modules such as those of FIG. 1.

In block S300, the channel locking module 100 scans and locks a downstream channel. In block S302, the message receiving module 102 receives the plurality of frequency plan descriptors from the CMTS 20 over the locked downstream channel. If no frequency plan descriptor is received during a preset time period, then in block S300, the channel locking module 100 continuously scans and locks another downstream channel of the cable modem 10.

If one frequency plan descriptor is received, then in block S306, the message analyzing module 104 determines if the plurality of frequency plan descriptors transmitted by the CMTS 20 are all received. If the plurality of frequency plan descriptors transmitted by the CMTS 20 are not all received, then in block S302, the message receiving module 102 continuously receives another frequency plan descriptor from the CMTS 20 over the locked downstream channel.

In block S308, the frequency obtaining module 106 obtains the frequency plan according to the frequency information field of the plurality of frequency plan descriptors if the frequency plan descriptors transmitted by the CMTS 20 are all received. In block S310, the channel locking module 100 scans and locks other downstream channels of the cable modem 10 according to the obtained frequency plan.

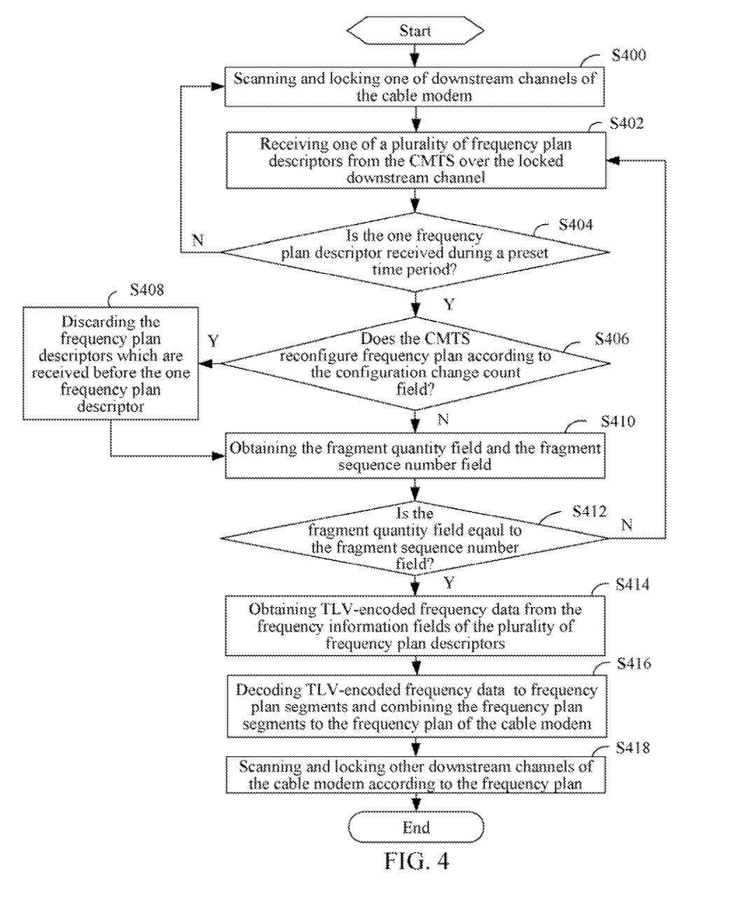

FIG. 4 is a flowchart of another embodiment of a downstream channel locking method of the present disclosure. The method may be embodied in the cable modem 10, and is executed by the functional modules such as those of FIG. 1.

In block S400, the channel locking module 100 scans and locks one of downstream channels of the cable modem. In block S402, the message receiving module 102 receives one of the plurality of frequency plan descriptors from the CMTS 20 over the locked downstream channel. Each frequency plan descriptor includes the configuration change count field, the fragment quantity field, the fragment sequence number field, and the frequency information field, which are shown in FIG. 2.

If none of frequency plan descriptors is received during a preset time period, then in block S400, the channel locking module 100 continuously scans and locks another downstream channel of the cable modem 10.

If one frequency plan descriptor is received, then in block S406, the message analyzing module 108 determines whether the CMTS 20 reconfigures the frequency plan for the cable modem 10 or not according to the configuration change count field of the currently received frequency plan descriptor. In block S408, the message analyzing module 104 discards the frequency plan descriptors which are received before the currently received frequency plan descriptor if the CMTS 20 reconfigures the frequency plan for the cable modem 10.

In block S410, the message analyzing module 104 obtains the fragment quantity field and the fragment sequence number field of the currently received frequency plan descriptor. In block S412, the message analyzing module 104 determines if the fragment quantity field is equal to the fragment sequence number field of the currently received frequency plan descriptor. If the fragment quantity field is unequal to the fragment sequence number field of the currently received frequency plan descriptor, then in block S402, the message receiving module 102 continuously receives the frequency plan descriptors from the CMTS 20 over the locked downstream channel.

If the fragment quantity field is equal to the fragment sequence number field of the currently received frequency plan descriptor, then in block S414, the frequency obtaining module 106 obtains the TLV-encoded frequency data from the frequency information fields of the plurality of frequency plan descriptors. In block S416, the frequency obtaining module 106 decodes the TLV-encoded frequency data to the frequency plan segments and combines the frequency plan segments to the frequency plan of the cable modem 10. In block S418, the channel locking module 100 scans and locks other downstream channels of the cable modem 10 according to the obtained frequency plan.

The cable modem 10 and the downstream channel locking method of the present disclosure only requires scanning according to the frequency plan configured by the CMTS 20, which decreases the total scanned frequency number. Therefore, the first time provisioning of the cable modem 10 is expedited and user satisfaction is improved.

While various embodiments of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A cable modem, comprising:
a processor; and
a storage system storing one or more programs that are operable to be executed by the processor, the one or more programs comprising:
a channel locking module to scan and lock one of a plurality of downstream channels of the cable modem;
a message receiving module to receive a plurality of frequency plan descriptors from a cable modem terminal system (CMTS) over the locked downstream channel, wherein the plurality of frequency plan descriptors is employed by the CMTS to transmit frequency plan which is divided into a plurality of frequency plan segments, and each of the frequency plan descriptors comprises a fragment quantity field to indicate a total quantity of the plurality of the frequency plan descriptors, a fragment sequence number field to indicate a sequence number of the current frequency plan descriptor in the plurality of the frequency plan descriptors, and a frequency information field to record one of the frequency plan segments;
a message analyzing module to determine if the plurality of frequency plan descriptors transmitted by the CMTS are all received according to the fragment quantity field and the fragment sequence number field of each received frequency plan descriptor; and
a frequency obtaining module to obtain the frequency plan according to the frequency information fields of the plurality of frequency plan descriptors upon the condition that the plurality of frequency plan descriptors transmitted by the CMTS are all received;
wherein the channel locking module scans and locks other downstream channels of the cable modem according to the obtained frequency plan.

2. The cable modem as claimed in claim 1, wherein the channel locking module further continuously scans and locks another downstream channel of the cable modem upon the condition that the message receiving module receives none of the plurality of frequency plan descriptors during a preset time period.

3. The cable modem as claimed in claim 1, wherein the message receiving module further continuously receives the plurality of frequency plan descriptors from the CMTS over the locked downstream channel upon the condition that the plurality of frequency plan descriptors transmitted by the CMTS are not all received.

4. The cable modem as claimed in claim 1, wherein each of the plurality of frequency plan descriptors further comprises a configuration change count field to indicate whether the CMTS reconfigures the frequency plan for the cable modem or not.

5. The cable modem as claimed in claim 4, wherein the message analyzing module further determines whether the CMTS reconfigures the frequency plan for the cable modem or not according to the configuration change count field of each of the plurality of frequency plan descriptors.

6. The cable modem as claimed in claim 5, wherein the message receiving module further discards the frequency plan descriptors which are received before a currently received frequency plan descriptor upon the condition that the CMTS reconfigures the frequency plan for the cable modem.

7. The cable modem as claimed in claim 1, wherein the message analyzing module determines that the plurality of frequency plan descriptors transmitted by the CMTS are all received upon the condition that the fragment quantity field is equal to the fragment sequence number field of a currently received frequency plan descriptor.

8. The cable modem as claimed in claim 1, wherein the message analyzing module determines that the plurality of frequency plan descriptors transmitted by the CMTS are not all received upon the condition that the fragment quantity field is not equal to the fragment sequence number field of a currently received frequency plan descriptor.

9. The cable modem as claimed in claim 1, wherein the CMTS encodes the frequency plan segments to type-length-value-encoded (TLV-encoded) frequency data and stores the TLV-encoded frequency data corresponding to one of the frequency plan segments in the frequency information field of one of the plurality of frequency plan descriptors.

10. The cable modem as claimed in claim 9, wherein the frequency obtaining module obtains the TLV-encoded frequency data from the frequency information fields of the plurality of frequency plan descriptors, decodes the TLV-encoded frequency data to the frequency plan segments, and combines the frequency plan segments to the frequency plan.

11. A downstream channel locking method of a cable modem, comprising:
scanning and locking one of downstream channels of the cable modem;
receiving a plurality of frequency plan descriptors from a cable modem terminal system (CMTS) over the locked downstream channel, wherein the plurality of frequency plan descriptors is employed by the CMTS to transmit frequency plan which is divided into a plurality of frequency plan segments, and each of the frequency plan descriptors comprises a fragment quantity field to indicate a total quantity of the plurality of the frequency plan descriptors, a fragment sequence number field to indicate a sequence number of the current frequency plan descriptor in the plurality of the frequency plan descriptors, and a frequency information field to record one of the frequency plan segments;
determining if the plurality of frequency plan descriptors transmitted by the CMTS are all received according to the fragment quantity field and the fragment sequence number field of the currently received frequency plan descriptor;
obtaining the frequency plan according to the frequency information fields of the plurality of frequency plan descriptors if the plurality of frequency plan descriptors transmitted by the CMTS are all received; and
scanning and locking other downstream channels of the cable modem according to the obtained frequency plan.

12. The method as claimed in claim 11, further comprises:
continuously scanning and locking another downstream channel of the cable modem upon the condition that the message receiving module receives none of the plurality of frequency plan descriptors during a preset time period.

13. The method as claimed in claim 11, further comprises: continuously receiving the plurality of frequency plan descriptors from the CMTS over the locked downstream channel upon the condition that the plurality of frequency plan descriptors transmitted by the CMTS are not all received.

14. The method as claimed in claim 11, wherein each of the plurality of frequency plan descriptors further comprises a configuration change count field to indicate whether the CMTS reconfigures the frequency plan for the cable modem or not.

15. The method as claimed in claim 14, further comprising: determining whether the CMTS reconfigures the frequency plan for the cable modem or not according to the configuration change count field of the currently received frequency plan descriptor.

16. The method as claimed in claim 15, further comprising: discarding the frequency plan descriptors which are received before the currently received frequency plan descriptor if the CMTS reconfigures the frequency plan for the cable modem.

17. The method as claimed in claim 16, wherein the block of determining if the plurality of frequency plan descriptors transmitted by the CMTS are all received comprises:
obtaining the fragment quantity field and the fragment sequence number field of the currently received frequency plan descriptor;
determining if the fragment quantity field is equal to the fragment sequence number field of the currently received frequency plan descriptor;
determining that the plurality of frequency plan descriptors transmitted by the CMTS are all received if the fragment quantity field is equal to the fragment sequence number field of the currently received frequency plan descriptor; or
determining that the plurality of frequency plan descriptors transmitted by the CMTS are not all received if the fragment quantity field is not equal to the fragment sequence number field of the currently received frequency plan descriptor.

18. The method as claimed in claim 11, wherein the CMTS encodes the frequency plan segments to type-length-value-encoded (TLV-encoded) frequency data and stores the TLV-encoded frequency data corresponding to one of the frequency plan segments in the frequency information field of one of the plurality of frequency plan descriptors.

19. The method as claimed in claim 18, wherein the block of obtaining the frequency plan according to the frequency information fields of the plurality of frequency plan descriptors comprises:
obtaining the TLV-encoded frequency data from the frequency information fields of the plurality of frequency plan descriptors;
decoding the TLV-encoded frequency data to the frequency plan segments; and
combining the frequency plan segments to the frequency plan.
